(19) United States
(12) Patent Application Publication
(10) Pub. No.: US 2025/0075766 A1
(43) Pub. Date: Mar. 6, 2025

(54) SHOCK-ABSORBING STRUCTURE, IN PARTICULAR FOR A MOTOR VEHICLE

(71) Applicant: VALEO SYSTEMES THERMIQUES, La Verriere (FR)

(72) Inventors: Jean-Yves BESNARD, La Verriere (FR); Sergio DA-COSTA-PITO, La Verriere (FR); Sylvain GERBER, La Verriere (FR)

(73) Assignee: VALEO SYSTEMES THERMIQUES, La Verriere (FR)

(21) Appl. No.: 18/823,101

(22) Filed: Sep. 3, 2024

(30) Foreign Application Priority Data
Sep. 1, 2023 (FR) 2309190

(51) Int. Cl. F16F 7/12; B62D 21/15

(52) U.S. Cl. CPC F16F 7/124; B62D 21/15; F16F 2224/0241; F16F 2226/04; F16F 2236/04

(57) ABSTRACT

The invention relates to a shock-absorbing structure, in particular for a motor vehicle, having a main direction of shock absorption, and having at least one profiled member made of composite material containing reinforcing fibers, this profiled member having a substantially cylindrical shape having a straight-line generatrix, this straight-line generatrix being oriented in the main direction of shock absorption.

### TECHNICAL FIELD

The present invention relates to a shock-absorbing structure, in particular for a motor vehicle.

### BACKGROUND OF THE INVENTION

In current hybrid or electric vehicles, the battery modules are often placed on a floor of the vehicle, in particular under the seats. The integration of battery modules into the car requires maximum space for their storage and reliable protection of the battery cells against shocks, for example against side impacts that occur when the car hits a pole on the side of the car.

A current trend is to use steel or aluminum profiles placed on the side rails for the protection of the battery modules. These extruded profiles are heavier and generate an additional cost. In addition, the use of aluminum increases the CO2 footprint.

### SUMMARY OF THE INVENTION

The invention aims to solve at least some of the aforementioned drawbacks.

One subject of the present invention is thus a shock-absorbing structure, in particular for a motor vehicle, having a main direction of shock absorption, and comprising at least one profiled member made of composite material containing reinforcing fibers, this profiled member having a substantially cylindrical shape having a straight-line generatrix, this straight-line generatrix being oriented in the main direction of shock absorption.

In the case of a profiled member obtained by pultrusion, the reinforcing fibers are oriented along the straight-line generatrix.

A cylinder is a surface in space defined by parallel straight lines (the generatrices). A cylindrical shape can be of closed or open contour, of circular or non-circular cross section. A corrugated shape is an example of a cylindrical shape.

In the present invention, the profiled member can have an exactly cylindrical shape or, in a variant, a shape which is slightly flared along the straight-line generatrix. In the latter case, the profiled member can be frustoconical in shape with an angle with respect to the straight-line generatrix which is relatively small, for example an angle less than or equal to 10°.

According to one of the aspects of the invention, the shock-absorbing structure has a generally elongate shape with a longitudinal axis, and the straight-line generatrix of the profiled member is substantially perpendicular to the longitudinal axis of the shock-absorbing structure.

According to one of the aspects of the invention, the shock-absorbing structure has a length measured along the longitudinal axis of at least 20 cm, in particular of at least 50 cm, or of at least 70 cm or 80 cm or 1 m.

According to one of the aspects of the invention, the shock-absorbing structure comprises a plurality of profiled members arranged with their straight-line generatrices all oriented in the main direction of shock absorption.

According to one of the aspects of the invention, the number of profiled members within the shock-absorbing structure is between 5 and 50, in particular between 20 and 40.

According to one of the aspects of the invention, the plurality of profiled members are arranged side by side, in particular in one or more rows.

According to one of the aspects of the invention, the plurality of profiled members are arranged in mutual contact with one another, in particular by being tangential in pairs.

According to one of the aspects of the invention, the plurality of profiled members are identical to one another.

In a variant, the profiles differ from one another, having different shapes and/or dimensions.

According to one of the aspects of the invention, the profiled member has a cylindrical shape of revolution, namely of circular cross section.

According to one of the aspects of the invention, the profiled member has a chamfered edge, in particular resulting from a geometrical cutting between the cylinder and an oblique cutting plane.

According to one of the aspects of the invention, the profiled member has a diameter of between 10 and 500 mm, preferably between 10 and 250 mm, and more preferably between 40 mm and 100 mm

According to another of the aspects of the invention, the profiled member comprises, in a cross section perpendicular to its straight-line generatrix, at least one open contour configured to receive a contour of the adjacent profiled member.

According to one of the aspects of the invention, the open contour is C-shaped.

According to one of the aspects of the invention, the profiled member comprises, in cross section, a closed contour and an open contour joined together.

According to one of the aspects of the invention, the diameter of the closed contour is smaller than the diameter of the open contour.

According to one of the aspects of the invention, the open contour of one of the profiled members is configured to receive the closed contour of the other, adjacent profiled member.

According to one of the aspects of the invention, the closed contour of one of the profiled members is inserted into the open contour of the other profiled member by sliding the closed contour into the open contour in the direction of the straight-line generatrix.

According to one of the aspects of the invention, this manner of fitting together two adjacent profiled members does not require deformation of the profiled members.

According to one of the aspects of the invention, the shock-absorbing structure comprises a succession of profiled members that fit into the adjacent profiled member.

According to one of the aspects of the invention, the profiled member is obtained by extrusion or pultrusion.

In a variant embodiment of the invention, the profiled member is formed by at least one sheet of composite material containing in particular reinforcing fibers.

According to one of the aspects of the invention, the profiled member(s) is or are produced by a single sheet of composite material.

According to one of the aspects of the invention, the sheet has a corrugated shape.

According to one of the aspects of the invention, this sheet has at least 10 or 20 corrugations.

According to one of the aspects of the invention, the successive corrugations are identical. In a variant, in the succession of corrugations, some can have different shapes and/or dimensions.

According to one of the aspects of the invention, the corrugations develop along the longitudinal axis of the shock-absorbing structure.

According to one of the aspects of the invention, the sheet has chamfered edges at some of the corrugations, in particular at each of the corrugations.

According to one of the aspects of the invention, the sheet is a pre-impregnated composite plate whose corrugations are obtained by thermoforming, in particular in a mold. The sheet could also be obtained by extrusion or pultrusion in pieces and by cuts to have the desired width (for example a width corresponding to the transverse direction of the vehicle) and with assembly of the pieces.

According to one of the aspects of the invention, the shock-absorbing structure comprises shapes overmolded onto the profiled member(s).

According to one of the aspects of the invention, the overmolded shapes comprise at least one wall, in particular a plurality of walls.

According to one of the aspects of the invention, the walls can be parallel.

In the case of a corrugated sheet, the overmolded shapes comprise corrugated shapes, in particular corrugated shapes which are complementary to the corrugations of the sheet.

The shock-absorbing structure can thus comprise cylinders aligned side by side, each cylinder (or profiled member) being formed half by the sheet and half by an overmolded shape.

In this case, the sheet and the overmolded shapes define a one-piece part.

In a variant, the profiled member(s) is or are formed by two sheets of composite material, and each profiled member is in particular formed half by one of the sheets and half by the other of the sheets. For example, each sheet forms a succession of half-cylinders, and the half-cylinders of the two sheets face each other in pairs to form a row of complete cylinders which are the profiled members.

In this exemplary embodiment of the invention, the two sheets are assembled together, for example by welding.

The half-cylinders of each sheet are in particular tangential to a geometric plane. This geometric plane defines a joint plane between the two sheets.

In general, the cylinder(s) can be slightly flared, in particular with a flaring angle of less than or equal to 10°.

According to one of the aspects of the invention, at least one of the sheets, in particular both sheets, is/are produced with interface shapes, in particular obtained by overmolding, configured, for example, to enable the shock-absorbing structure to be fastened to a structural part of a motor vehicle.

According to one of the aspects of the invention, the interface shapes, which are in particular overmolded, are present over the entire length of the sheet.

According to one of the aspects of the invention, the interface shapes define strips of material, for example two parallel strips of material, which run along the edge(s) of the corrugations on the sheets.

According to another aspect of the invention, the interface shapes define a front wall and a rear wall, which are in particular planar and parallel, between which the half-cylinders formed by the sheet extend. For example, the opposite ends of each cylinder are respectively on the front wall and on the rear wall.

According to one of the aspects of the invention, the front wall and/or the rear wall have or has a cheek (in particular of substantially round or oval shape) placed in a notch of an overmolded shape of the other sheet. Thus, the cheek makes it possible to close one end of a cylinder resulting from the assembly of two half-cylinders of the two sheets.

The interface shapes (which are in particular overmolded) can be configured to produce the junction, in particular welded, between the two sheets.

According to one of the aspects of the invention, the interface shapes define bars, in particular parallel to one another, each bar being present at the junction between two adjacent half-cylinders of the sheet.

Of course, the interface shapes can have geometries other than those described above.

In general, as seen above, the corrugations of the shock-absorbing structure can be formed by a single sheet with, in addition, overmolded shapes, or, in a variant, by two sheets (possibly with each of the interface shapes) which are assembled, for example, by being welded together.

According to one of the aspects of the invention, the shock-absorbing structure comprises a reinforcing plate, for example made of steel or aluminum or a composite material, placed on one side of the profiled members, in particular on the side which is the rear of the profiled members (that is to say, for example, on the innermost side with respect to the vehicle). This reinforcing plate makes it possible to reinforce the mechanical strength of the shock-absorbing structure. This reinforcing plate extends in particular along the entire row of profiled members. The reinforcing plate is substantially rectangular, possibly with apertures.

According to one of the aspects of the invention, the shock-absorbing structure is configured to be placed on a lateral edge of a motor vehicle, for example inside a side rail.

In this case, the shock-absorbing structure can be arranged before assembly of the side rail, which comprises, for example, two shapes, for example two complementary half-shells, usually made of metal and assembled by welding.

According to one of the aspects of the invention, the shock-absorbing structure is configured to be integrated on one or more floor crossmembers.

According to one of the aspects of the invention, the shock-absorbing structure is configured to be placed on a lateral edge of an energy storage device, in particular comprising battery cells.

According to one of the aspects of the invention, the energy storage device is placed on a floor of a motor vehicle.

According to one of the aspects of the invention, the profiled members comprise shapes, in particular end shapes, configured to enable fastening or assembly thereof within a side rail of the vehicle.

According to one of the aspects of the invention, the shock-absorbing structure comprises one or more shock-absorbing foams within the cavities of the profiled members.

Another subject of the invention is an assembly comprising an energy storage device and a shock-absorbing structure as described above and configured to be placed on a lateral edge of the energy storage device.

According to one of the aspects of the invention, the shock-absorbing structure is configured to be placed on a lateral edge of a motor vehicle, for example inside a side rail.

Another subject of the invention is a vehicle with the aforementioned assembly.

The invention is advantageous in that the shock-absorbing structure makes it possible to effectively absorb shocks occurring against this shock-absorbing structure. Specifically, the profiled member(s) is or are positioned so as to have the maximum resistance to a compressive force, for the main direction of shock absorption.

When the profiled member(s) is or are produced by extrusion or pultrusion, the reinforcing fibers are oriented in the extrusion or pultrusion direction so that the profiled member(s) has or have, along the straight-line generatrix, the maximum resistance to a compressive force.

This arrangement of the profiled member(s) is more advantageous in terms of resistance to compression than, for example, the case where the profiled member is placed with its straight-line generatrix perpendicular to the main direction of shock absorption.

In other words, it can be said that the reinforcing fibers are aligned in the main direction of shock absorption so as to offer a high compression performance.

Another subject of the invention is a method for manufacturing a shock-absorbing structure, in particular for a motor vehicle, having a main direction of shock absorption, the method comprising the following steps:
producing at least one profiled member made of composite material containing reinforcing fibers, this profiled member having a cylindrical shape having a straight-line generatrix, in particular by pultrusion or extrusion,
optionally cutting the profiled member to a predetermined size,
placing this profiled member within the shock-absorbing structure with an orientation such that the straight-line generatrix is oriented in the main direction of shock absorption.

By virtue of the pultrusion process, reinforcing fibers which are continuous are produced, and in the case of an application to a vehicle side rail reinforcement, the orientation of the continuous reinforcing fibers is in the transverse direction of the vehicle. Owing to the pultrusion process with continuous movement of the material leaving the pultrusion machine, the known use is, by contrast, to use the continuous fibers in the longitudinal direction of the vehicle.

In the invention, there is a cutting step, after pultrusion, to have the profiled members of predetermined sizes, then an assembly step to have the shock-absorbing structure with a predetermined length.

The cutting makes it possible to adapt to various shapes, for example in a vehicle side rail.

As stated above, the invention makes it possible to have an orientation of the continuous fibers in the main direction of the impact.

The method can comprise the step of forming the profiled members by assembling (in particular by welding) two sheets of composite material (in particular preformed with corrugations), and each profiled member is formed substantially half by one of the sheets and half by the other of the sheets.

In a variant, the method can comprise the step of forming the profiled members on a single sheet of composite material, with overmolded shapes.

### BRIEF DESCRIPTION OF DRAWINGS

Other features, details and advantages of the invention will become more clearly apparent on reading the following description, on the one hand, and from several exemplary embodiments given by way of non-limiting indication with reference to the attached schematic drawings, on the other hand, in which drawings:

FIG. 1 is a schematic and partial representation, in perspective, of an assembly with two shock-absorbing structures according to one example of the invention;

FIG. 2 is a schematic and partial representation, in perspective, of one of the shock-absorbing structures of FIG. 1;

FIG. 3 is a sectional view of a profiled member of the shock-absorbing structure of FIG. 2;

FIG. 4 is a schematic and partial representation of a shock-absorbing structure according to another example of the invention;

FIG. 5 is a perspective view of a profiled member of the shock-absorbing structure of FIG. 4;

FIG. 6 is a schematic and partial representation of a sheet of a shock-absorbing structure according to another example of the invention;

FIG. 7 is a perspective representation of the shock-absorbing structure of FIG. 6;

FIG. 8 is a perspective representation of a shock-absorbing structure according to another example of the invention;

FIG. 9 is a perspective representation of the shock-absorbing structure of FIG. 8 in an exploded view; and

FIG. 10 is a perspective representation of the shock-absorbing structure of FIG. 8, with the various elements shown separately.

### DETAILED DESCRIPTION OF THE INVENTION

The features, variants and different embodiments of the invention can be combined with one another in various combinations, provided that they are not mutually incompatible or mutually exclusive. In particular, variants of the invention can be imagined comprising only a selection of features described hereinafter in isolation from the other features described, if this selection of features is sufficient to confer a technical advantage and/or to differentiate the invention from the prior art.

FIG. 1 shows very schematically two shock-absorbing structures 1 for a motor vehicle V (of which only a few parts can be seen in FIG. 1), belonging to an assembly 100 comprising an energy storage device 101. This energy storage device 101 comprises battery cell modules (not shown) and is placed on a floor of the vehicle V.

The shock-absorbing structures 1 are placed respectively on two parallel lateral edges of the energy storage device 101, namely on two sides of the vehicle.

Each shock-absorbing structure 1 is configured to be placed/integrated in a side rail of the vehicle V.

Each shock-absorbing structure 1 has a main direction of shock absorption DP which is transverse with respect to the longitudinal direction DL of the vehicle. Each shock-absorbing structure 1 is adapted to withstand impacts that occur laterally on the vehicle.

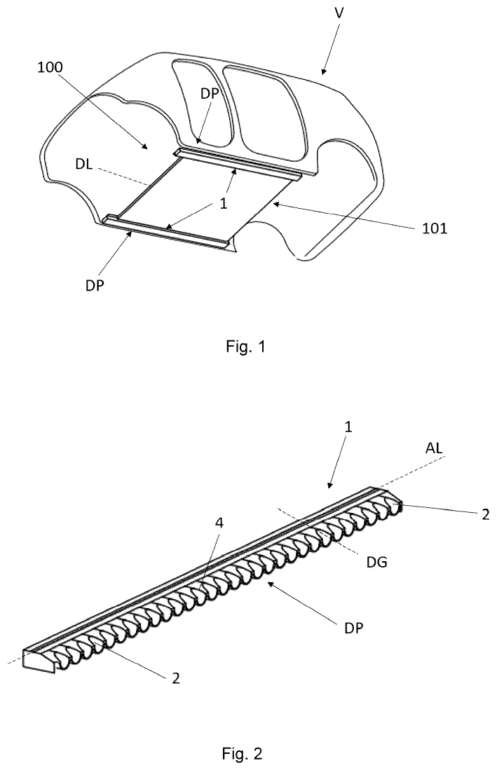

In the example described, as better shown in FIG. 2, each shock-absorbing structure 1 comprises a row of profiled members 2 made of composite material, for example a polymer material, containing reinforcing fibers, for example glass or carbon fibers. The profiled members 2, all identical, are joined together in the row.

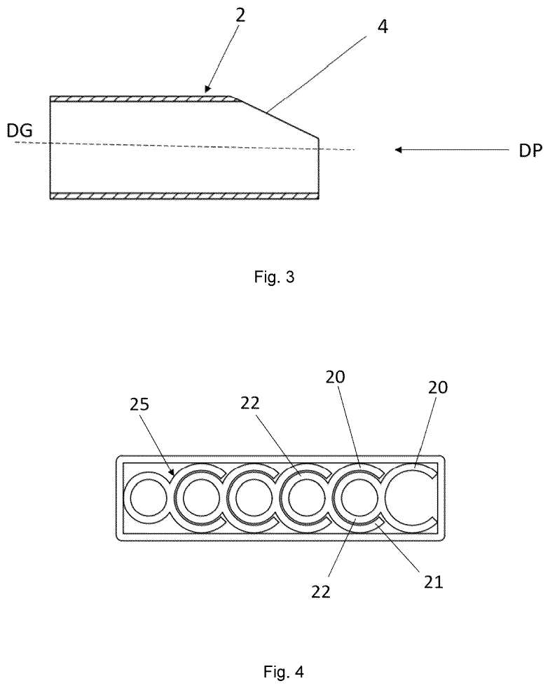

Each profiled member 2 has a cylindrical shape having a straight-line generatrix DG, this straight-line generatrix being oriented in the main direction of shock absorption DP, as illustrated in FIG. 3.

The profiled members 2 are obtained by pultrusion, and the reinforcing fibers are oriented along the straight-line generatrix DG.

The profiled members 2 have, in cross section, a circular shape.

The shock-absorbing structure 1 has a generally elongate shape with a longitudinal axis AL, and the straight-line generatrix DG of the profiled members 2 is substantially perpendicular to the longitudinal axis AL of the shock-absorbing structure 1. The longitudinal axis AL of the shock-absorbing structure 1 is substantially parallel to the longitudinal direction DL of the vehicle.

This arrangement of the profiled members 2 is more advantageous in terms of resistance to compression than, for example, the case where the profiled member is placed with its straight-line generatrix DG perpendicular to the main direction DP of shock absorption.

In other words, it can be said that the reinforcing fibers are aligned in the main direction DP of shock absorption so as to offer a high compression performance.

The shock-absorbing structure has a length measured along the longitudinal axis AL of at least 20 cm, in particular of at least 50 cm, or of at least 70 cm or 80 cm or 1 m.

The plurality of profiled members 2 are arranged with their straight-line generatrices DG all oriented in the main direction of shock absorption DP.

The number of profiled members within the shock-absorbing structure 1 is between 5 and 50, in particular between 20 and 40.

The plurality of profiled members 2 are arranged in mutual contact with one another, being tangential in pairs.

Each profiled member 2 has a chamfered edge 4, resulting from a geometrical cutting between the cylinder and an oblique cutting plane.

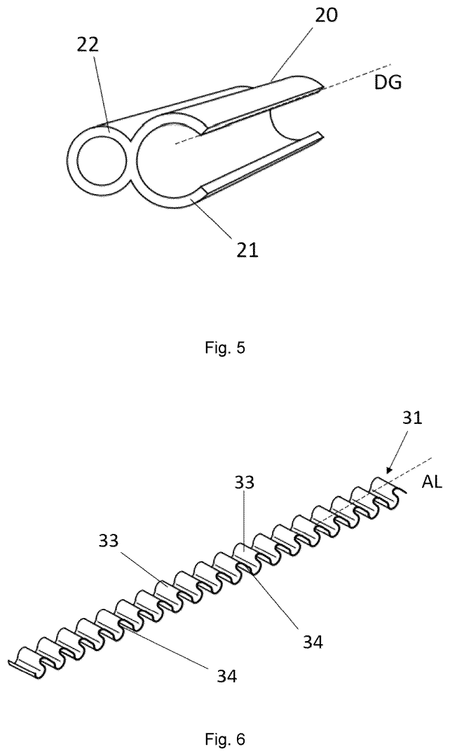

In another exemplary embodiment of the invention illustrated in FIGS. 4 and 5, the profiled member 20 comprises, in a cross section perpendicular to its straight-line generatrix DG, an open contour 21 configured to receive a contour of the adjacent profiled member 20.

The open contour 21 has a C shape.

In the example described, each profiled member 20 comprises, in cross section, a closed contour 22 and an open contour 21 joined together.

The diameter of the closed contour 22 is smaller than the diameter of the open contour 21.

The open contour 21 of one of the profiled members 20 is configured to receive the closed contour 22 of the other, adjacent profiled member.

The closed contour 22 of one of the profiled members is inserted into the open contour 21 of the other profiled member by sliding the closed contour 22 into the open contour 21 in the direction of the straight-line generatrix DG.

This way of fitting two adjacent profiled members 20 does not require deformation of the profiled members.

Here, the shock-absorbing structure 25 comprises a succession of profiled members 20 that fit into the adjacent profiled member.

The profiled member 20 is obtained by extrusion or pultrusion.

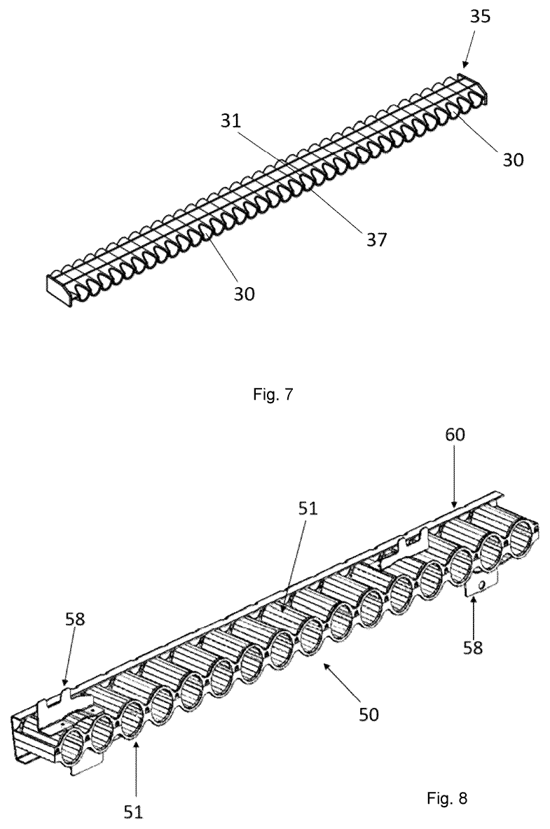

In a variant embodiment of the invention illustrated in FIGS. 6 and 7, the profiled member 30, which has overall the same shape as the profiled members 2 described above, is formed by a sheet 31 of composite material containing reinforcing fibers.

The sheet 31 has a corrugated shape, with between 10 and 20 corrugations 33. The successive corrugations are identical. In a variant, in the succession of corrugations, some can have different shapes and/or dimensions.

The corrugations 33 develop along the longitudinal axis AL of the shock-absorbing structure 35.

The sheet 31 comprises chamfered edges 34 at each of the corrugations 33.

The corrugations 33 of the sheet 31 are obtained by shaping the sheet while hot in a mold. The sheet 31 could also be obtained by extrusion or pultrusion in pieces and by cuts to have the desired width (for example a width corresponding to the transverse direction of the vehicle) and with assembly of the pieces.

The shock-absorbing structure 35 comprises overmolded shapes 37 to form the profiled members 30.

The overmolded shapes 37 comprise corrugated shapes, here corrugated shapes which are complementary to the corrugations 33 of the sheet.

The shock-absorbing structure 35 can thus comprise cylinders aligned side by side, each cylinder being formed half by the sheet 31 and half by an overmolded shape 37.

In general, the shock-absorbing structure 1, 25 or 35 can be arranged before assembly of the side rail which comprises, for example, two shapes, for example two complementary half-shells, usually made of metal and assembled by welding.

In a variant, the shock-absorbing structure 1, 25 or 35 is configured to be integrated on one or more floor crossmembers.

The shock-absorbing structure 1, 25 or 35 could comprise one or more shock-absorbing foams within the cavities of the profiled members.

A description will now be given, with reference to FIGS. 8, 9 and 10, of a shock-absorbing structure 50 according to another exemplary embodiment of the invention.

As in the examples described above, the shock-absorbing structure 50 comprises profiled members 51 in the form of cylinders.

The profiled members 51 are formed by two sheets 52 of composite material (visible in isolation in FIG. 10), and each profiled member 51 is formed half by one of the sheets 52 and half by the other of the sheets 52. In particular, each sheet 52 forms a succession of half-cylinders 53, and the half-cylinders 53 of the two sheets 52 face one another in pairs to form a row of complete cylinders which are the profiled members 51.

In this exemplary embodiment of the invention, the two sheets 52 are assembled together by welding.

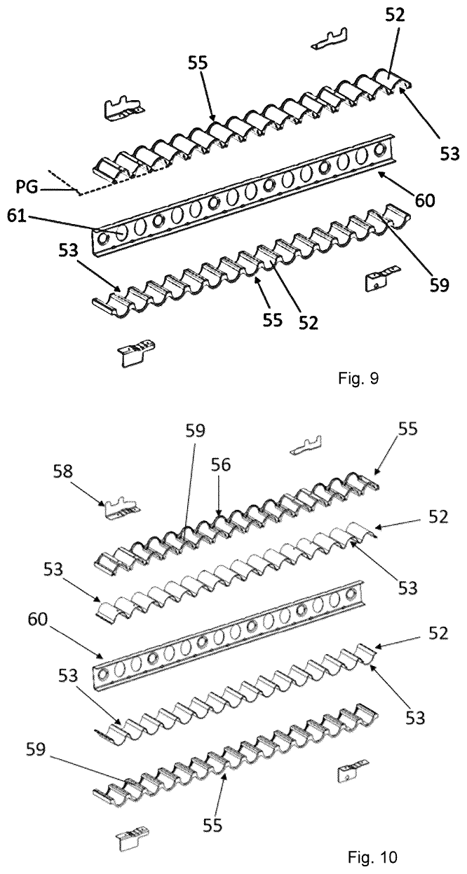

The half-cylinders 53 of each sheet 52 are tangential to a geometric plane PG illustrated in FIG. 9. This geometric plane defines a joint plane between the two sheets 52.

The two sheets 52 are produced with interface shapes 55, obtained by overmoulding, configured to allow the shock-absorbing structure 50 to be fastened to a structural part (not shown) of a motor vehicle. These interface shapes 55 are shown in FIG. 10, isolated from the sheets 52 for the purposes of explanation.

However, it must be understood that these interface shapes 55 are connected to the sheets 52 as a result of the overmoulding, as is shown in FIG. 9. The two sheets 52 with their interface shapes 55 are assembled together as two separate parts.

The interface shapes 55, made of plastic, are present over the entire length of the sheet 52, and define strips of material, here two parallel strips of material, which run along the edges of the corrugations on the sheet 52.

The interface shapes 55 thus form a corrugated frame 56 which surrounds the corresponding sheet 52.

Fastening lugs 58, for example made of metal, are fastened to the interface shapes 55, making it possible to secure the shock-absorbing structure 50 to a structural part of the motor vehicle.

The interface shapes 55 are configured to form the junction, by welding, between the two sheets 52.

The interface shapes 55 define mutually parallel bars 59, each bar being present at the junction between two adjacent half-cylinders 53 of the sheet 52.

Of course, the interface shapes can have geometries other than those described above.

The shock-absorbing structure 50 comprises a reinforcing plate 60, for example made of steel or aluminum or a composite material, placed on one side of the profiled members 51, here on the side which is the rear of the profiled members (that is to say, for example, on the innermost side with respect to the vehicle). This reinforcing plate 60 makes it possible to reinforce the mechanical strength of the shock-absorbing structure 50. This reinforcing plate 60 extends all along the row of profiled members 51. The reinforcing plate 60 is substantially rectangular, with apertures 61 (apertures which in particular allow weight to be lightened).

What is claimed is:

1. A shock absorbing structure comprising a main direction of shock absorption, at least one profiled member made of composite material containing reinforcing fibers and having a substantially cylindrical shape with a straight-line generatrix with the straight-line generatrix being oriented in the main direction of shock absorption.

2. The shock-absorbing structure according to claim 1, wherein the at least one profiled member is formed by at least one sheet made of composite material containing reinforcing fibers.

3. The shock-absorbing structure according to the preceding claim 2, wherein the at least one profiled member is produced by a single sheet of composite material containing reinforcing fibers.

4. The shock-absorbing structure according to claim 2, wherein the at least one profiled member is formed by two sheets of composite material containing reinforcing fibers.

5. The shock-absorbing structure according to claim 4, wherein at least one of the two sheets is produced with interface shapes.

6. The shock-absorbing structure according to claim 1, having a generally elongate shape with a longitudinal axis, with the straight-line generatrix of the at least one profiled member is being substantially perpendicular to the longitudinal axis of the shock-absorbing structure.

7. The shock-absorbing structure according to claim 1, wherein a plurality of the profiled members are arranged side by side.

8. An assembly comprising an energy storage device and a shock-absorbing structure having a main direction of shock absorption, at least one profiled member made of composite material containing reinforcing fibers and having a substantially cylindrical shape with a straight-line generatrix, with the straight-line generatrix being oriented in the main direction of shock absorption, the shock-absorbing structure being configured to be placed on a lateral edge of the energy storage device.

9. A method for manufacturing a shock-absorbing structure having a main direction of shock absorption, the method comprising:
producing at least one profiled member made of composite material containing reinforcing fibers, with the at least one profiled member having a cylindrical shape with a straight-line generatrix,
placing the at least one profiled member within the shock-absorbing structure with an orientation such that the straight-line generatrix is oriented in the main direction of shock absorption.

10. The method according to claim 9, further comprising forming the at least one profiled member by assembling two sheets of composite material, with each profiled member being formed substantially half by one of the sheets and half by the other of the sheets.

11. The shock-absorbing structure according to claim 4, wherein the at least one profiled member is formed half by one of the two sheets and half by the other of the two sheets.

12. A method according to claim 9, further comprising cutting the at least one profiled member to a predetermined size before placing the at least one profiled member within the shock-absorbing structure.
